(19) United States
(12) Patent Application Publication
(10) Pub. No.: US 2004/0189086 A1
(43) Pub. Date: Sep. 30, 2004

(54) Vehicle hydraulic brake device

(76) Inventor: Akihito Kusano, Kariya (JP)

Correspondence Address: BURNS DOANE SWECKER & MATHIS L L P, POST OFFICE BOX 1404, ALEXANDRIA, VA, 22313-1404, US

(21) Appl. No.: 10/808,376

(22) Filed: Mar. 25, 2004

(30) Foreign Application Priority Data
Mar. 26, 2003 (JP) 2003-085857

(51) Int. Cl. B60T 8/88

(52) U.S. Cl. 303/114.1

(57) ABSTRACT

In a vehicle hydraulic brake device, the hydraulic pressure supplied from a hydraulic pressure source is adjusted to a value proportional to the brake operating amount by a pressure adjusting valve, and a master cylinder is actuated under the output hydraulic pressure of the pressure adjusting valve introduced into a pressure chamber to produce braking force. The output hydraulic pressure of the pressure adjusting valve and that of the master cylinder are detected with a pressure sensor and a master cylinder pressure sensor and compared with a bottoming detector. If the output hydraulic pressure of the master cylinder does not meet a predetermined relation, and the bottoming detector determines that bottoming has occurred, and the output hydraulic pressure of the master cylinder at this time is not less than a predetermined first hydraulic pressure, a solenoid valve provided between the pressure adjusting valve and the master cylinder is opened, and a solenoid valve provided between the master cylinder and an atmospheric reservoir is closed to supply the output hydraulic pressure of the pressure adjusting valve to two of the four wheel cylinders through the master cylinder.

### BACKGROUND OF THE INVENTION

This invention relates to a vehicle hydraulic brake device, more specifically a vehicle hydraulic brake device in which even if bottoming develops in which due to vapor lock phenomenon, the master piston of the master cylinder makes a full stroke before sufficient braking force is obtained, sufficient braking force is obtainable.

JP patent publication 61-37140 discloses a prior art vehicle hydraulic brake device which includes a hydraulic pressure source having a power-driven pump for generating a predetermined hydraulic pressure, a pressure adjusting valve for adjusting the output hydraulic pressure of the hydraulic pressure source to a value proportional to the brake operating force, and a master cylinder for producing brake hydraulic pressure by actuating a master piston under the output hydraulic pressure of the pressure adjusting valve, and is adapted to impart braking force to the respective vehicle wheels by actuating the wheel cylinders under the output hydraulic pressure from the master cylinder.

In a vehicle hydraulic brake device having a master cylinder, if vapor lock phenomenon develops as a result of frequent brakings, there is a possibility that the master piston makes a full stroke while the braking force obtained is still low. If this happens, even if the brake is further stepped, the braking force will not increase any further.

If the driver fails to notice this, safety problem will arise. Thus, the vehicle hydraulic brake device disclosed in JP patent publication 61-37140 is provided with a device (display device) for directly detecting the stroke of the master piston.

Bottoming of the master cylinder can be detected not only by a method shown in JP patent publication 61-37140, namely, by directly detecting the stroke of the master piston, but also by comparing the brake operating amount with the output hydraulic pressure of the master cylinder.

But even though it is possible to detect bottoming and notify the driver of this fact, such conventional devices cannot increase the reduced braking force. Thus improvement in safety is needed.

An object of this invention is to improve safety if bottoming of the master piston occurs due to vapor lock phenomenon.

### SUMMARY OF THE INVENTION

According to this invention, there is provided a vehicle hydraulic brake device comprising a hydraulic pressure source for generating and outputting a predetermined hydraulic pressure, a pressure adjusting valve for adjusting the output hydraulic pressure of the hydraulic pressure source to a value proportional to a brake operating amount, a pressure chamber, a master cylinder having a master piston actuated under the output hydraulic pressure of the pressure adjusting valve introduced into a pressure chamber, or under the output hydraulic pressure of the pressure adjusting valve introduced into a pressure chamber and the brake operating force to generate brake hydraulic pressure, and wheel cylinders actuated by the output hydraulic pressure from the master cylinder to impart braking force to the respective wheels,

further comprising a bottoming detector for detecting the bottoming of the master piston, and a hydraulic pressure supply device for supplying the output hydraulic pressure of the pressure adjusting valve to a hydraulic system extending from the master cylinder to the wheel cylinders, the hydraulic pressure supply device supplying the output hydraulic pressure of the pressure adjusting valve to the hydraulic system when the bottoming detector detects the bottoming of the master piston.

As the hydraulic pressure supply device, any of the following four may be used.

\mathring{1} one which supplies the output hydraulic pressure of the pressure adjusting valve to the hydraulic system if the bottoming detector detects the bottoming of the master piston, and the output hydraulic pressure of the master cylinder at the time is not less than a predetermined first hydraulic pressure,

\mathring{2} one which starts supplying hydraulic pressure to the hydraulic system when the bottoming detector detects the bottoming of the master piston, and stops supplying hydraulic pressure to the hydraulic system when the output hydraulic pressure of the master cylinder and/or the output hydraulic pressure of the pressure adjusting valve is not more than a predetermined second hydraulic pressure,

\mathring{3} one which starts supplying hydraulic pressure to the hydraulic system when the bottoming detector detects the bottoming of the master piston, and stops supplying hydraulic pressure to the hydraulic system when a predetermined time has passed after starting supplying hydraulic pressure, or

\mathring{4} one which starts supplying hydraulic pressure to the hydraulic system when the bottoming detector detects the bottoming of the master piston, and stops supplying hydraulic pressure to the hydraulic system when a predetermined time has passed after the bottoming detector detects that as a result of supply of hydraulic pressure by the hydraulic pressure supply device, the master cylinder has recovered to a non-bottoming state.

Preferably, the bottoming detector includes an alarm which produces an alarm if it detects bottoming of the master piston.

Bottoming of the master piston may be detected by comparing the output hydraulic pressure of the pressure adjusting valve with the output hydraulic pressure of the master cylinder, or by comparing the brake operating amount (such as the pedal stroke or the stepping force applied to the brake pedal) with the output hydraulic pressure of the master cylinder.

In the vehicle hydraulic brake device of this invention, if bottoming of the master piston is detected by the bottoming detector, the output hydraulic pressure of the pressure adjusting valve is supplied to the hydraulic system extending from the master cylinder to the wheel cylinders, so that the hydraulic pressure in the wheel cylinders increases. Thus, even if e.g. a vapor lock phenomenon, which causes bottoming of the master piston, occurs, sufficient braking force is obtained. Thus the safety of the vehicle increases.

If the hydraulic pressure supply device begins to supply hydraulic pressure while the hydraulic system has lost its function of sealing hydraulic pressure due to failure in the hydraulic system from the master cylinder to the wheel cylinder such as leak of fluid, the hydraulic pressure of the pressure adjusting valve will decrease, producing a reverse effect. Thus, supply of hydraulic pressure by the hydraulic pressure supply device should be carried out after confirming that the output hydraulic pressure of the master cylinder is higher than a predetermined first hydraulic pressure, namely, that fluid is sealed.

The supply of hydraulic pressure by the hydraulic pressure supply device may be terminated when the output hydraulic pressure of the master cylinder and/or that of the pressure adjusting valve is not more than a predetermined second hydraulic pressure, when a predetermined time has passed from the start of supply of hydraulic pressure, or when a predetermined time has passed after the bottoming detector has detected that the master piston has recovered to a non-bottoming state. Thereby a sufficient braking force can be obtained.

By providing the bottoming detector with the alarm, it is possible to notify the driver of abnormality.

### BRIEF DESCRIPTION OF THE DRAWINGS

Other features and objects of the present invention will become apparent from the following description made with reference to the accompanying drawings, in which:

FIG. 1 is a view showing an embodiment of the vehicle hydraulic brake device of this invention;

FIG. 2 is a view showing another embodiment;

FIG. 3 is a flowchart for the supply of hydraulic pressure in the vehicle hydraulic brake device of FIG. 1; and

FIG. 4 is a flowchart for the supply of hydraulic pressure in the vehicle hydraulic brake device of FIG. 2.

### DETAILED DESCRIPTION OF THE PREFERRED EMBODIMENT

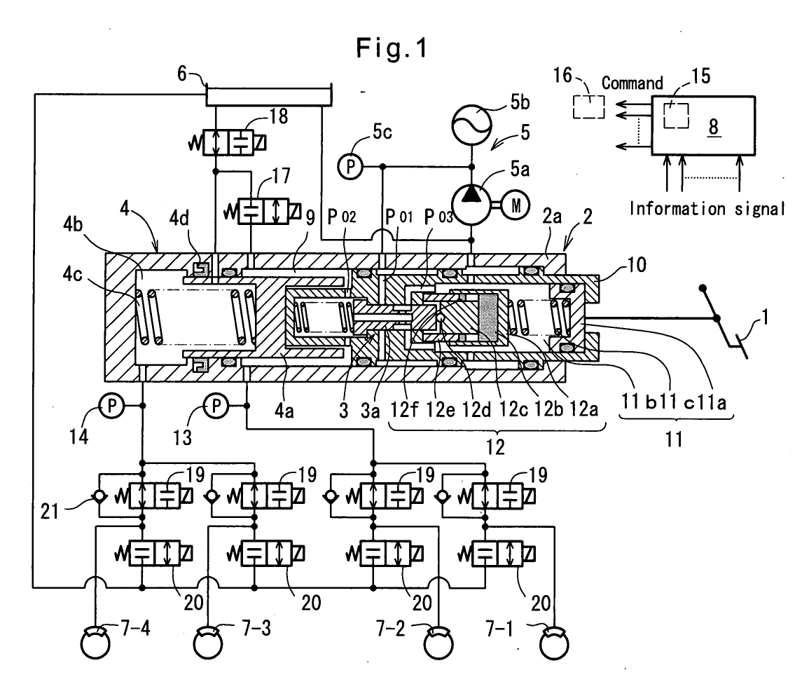

The embodiments of the vehicle hydraulic brake device of this invention will be described with reference to the attached drawings. FIG. 1 shows the vehicle hydraulic brake device of the first embodiment which includes a brake pedal 1, a pressure adjusting device 2 comprising a pressure adjusting valve 3 and a master cylinder 4 and having a boosting function, a hydraulic pressure source 5 including a power-driven pump 5a, an accumulator 5b for accumulating hydraulic pressure generated by the pump, and a hydraulic pressure sensor 5c, an atmospheric reservoir 6 communicating with the intake ports of the pump 5a and the master cylinder 4, wheel cylinders 7-1 to 7-4 for imparting braking force to the vehicle wheels, and an electronic control unit (ECU) 8.

In the hydraulic pressure source 5, when the hydraulic pressure detected by the hydraulic pressure sensor 5c reaches a preset lower limit, a command is given from the electronic control unit 8 which receives the signal from the hydraulic pressure sensor 5c, to actuate the pump 5a, and when the detected hydraulic pressure reaches a preset upper limit, the pump 5a will stop. Thus, in a normal state, hydraulic pressure in a predetermined range is always accumulated.

The pressure adjusting device 2 used is of a type that introduces the output hydraulic pressure of the pressure adjusting valve 3 into a pressure chamber 9 to actuate the master cylinder 4 under the hydraulic pressure.

An auxiliary piston 10 is provided in a housing 2a of the pressure adjusting device 2. The brake operating force applied to the brake pedal 1 is transmitted to the pressure adjusting valve 3 through a stroke simulator 11 and a distribution device 12 that are built in the auxiliary piston 10.

The stroke simulator 11 comprises a simulator piston 11a to which the brake operating force is applied from the brake pedal 1, and an elastic member 11c provided in an atmospheric simulator chamber 11b for imparting stroke corresponding to the brake operating force to the simulator piston 11a and transmitting the brake operating force to the distribution device 12.

The distribution device 12 comprises a cup-like member 12a, a rubber member 12b inserted in the cup-like member, a transmission member 12c and a steel ball 12d that are disposed between the rubber member 12b and the pressure adjusting valve 3, a tubular member 12e having one end thereof in abutment with the auxiliary piston 10 and the other end inserted in the cup-like member 12a. (To the tip of the member 12e, a resin annular plate 12f is mounted to protect the rubber member 12b which is elastically deformed and gets into a gap between the cup-like member 12a and the transmission member 12c during brake operation.)

By providing the distribution device 12, although the brake operating force applied to the cup-like member 12a is transmitted to the pressure adjusting valve 3 as it is in the initial stage of brake operation, when the brake operating force exceeds a certain value, the rubber member 12b will get elastically deformed, get into the gap between the cup-like member 12a and the transmission member 12c, and abut the resin annular plate 12f. Thereafter, only part of the brake operating force is transmitted to the pressure adjusting valve 3. Thus, using this function, it is possible to impart to the brake device jumping property, that is, making steep the initial uprise of the brake pressure adjusted by the pressure adjusting valve 3 (output hydraulic pressure of the pressure adjusting valve). Also, it is possible to change the relation between the brake operating force and the output hydraulic pressure of the pressure adjusting valve by replacing the rubber member 12b with one having different properties and/or size. But the distribution device 12 is merely a preferable element.

The pressure adjusting valve 3 shown is a type in which the auxiliary piston 10 has an input port P01, output port P02, and a pressure reduction port P03 with the input port P01 connected to the hydraulic pressure source 5 through a fluid chamber formed on the outer periphery of the auxiliary piston 10, the output port P02 connected to the wheel cylinders 7-1 and 7-2 through the pressure chamber 9, and the pressure reduction port P03 connected to the atmospheric reservoir 6 through the simulator chamber 11b and the fluid chamber formed on the outer periphery of the auxiliary piston 10 so that changeover of connection of the output port P02 to the input port P01 and the pressure reduction port P03, disconnection of the output port P02 from both the input port P01 and the pressure reduction port P03, and the adjustment of the degree of opening of the valve portion are carried out by the displacement of a spool 3a having an internal passage. Since such a pressure adjusting valve 3 which adjusts the hydraulic pressure supplied from the hydraulic pressure source 5 to a value corresponding to the brake operating amount by the displacement of the spool 3a is well known, its detailed description is omitted here.

The output hydraulic pressure of the pressure adjusting valve 3 is introduced into the pressure chamber 9 through the output port P02. Under the hydraulic pressure, the master piston 4a advances compressing a return spring 4c, thereby producing brake hydraulic pressure proportional to the brake operating amount in the master hydraulic chamber 4b.

To the wheel cylinders 7-1 and 7-2, which are in the first hydraulic system, the output hydraulic pressure of the pressure adjusting valve 3 is supplied, while the hydraulic pressure produced in the master cylinder 4 is supplied to the wheel cylinders 7-3 and 7-4, which are in the second hydraulic system.

While this vehicle hydraulic brake device is functioning normally and the output hydraulic pressure of the pressure adjusting valve 3 is being introduced into the pressure chamber 9, the auxiliary piston 10 will bear the introduced hydraulic pressure and be held in the illustrated position. If hydraulic pressure is not introduced into the pressure chamber 9 when it should be introduced into it, the auxiliary piston 10 is pushed leftwardly in the figure under the brake operating force, so that the brake operating force is directly transmitted to the master piston 4a through the auxiliary piston 10. Thus, even if the hydraulic pressure source 5 fails, at least the master cylinder pressure by manual actuation is ensured so that the minimum required braking force is ensured.

In FIG. 1, a pressure sensor 13 for detecting the output hydraulic pressure of the pressure adjusting valve 3, and a master cylinder pressure sensor 14 for detecting the output hydraulic pressure of the master cylinder 4 are shown. In the vehicle hydraulic brake device of FIG. 1, the output hydraulic pressure of the pressure adjusting valve as detected by the pressure sensor 13 is compared with that of the master cylinder as detected by the master cylinder pressure sensor 14 by a bottoming detecting means 15.

The bottom detecting means 15 is an electrical comparison/judging circuit, which determines that bottoming of the master piston 4a has occurred if the output hydraulic pressure of the master cylinder 4 gets out of a predetermined relation. If necessary, the bottoming detecting means 15 may be accompanied with an alarm means 16 so that if bottoming occurs, an alarm will be given to the driver.

The alarm means 16 may be an ordinary alarm device that visually or audibly notifies abnormality.

Further, a normally closed solenoid valve 17 is provided between the pressure chamber 9 and the intake port of the master cylinder 4, and a normally open solenoid valve 18 is provided which shuts off communication between the pressure chamber 9 and the atmospheric reservoir 6 if the solenoid valve 17 opens. By the hydraulic pressure supply means formed by them, the output hydraulic pressure of the pressure adjusting valve 3 is supplied as necessary, to the second hydraulic system which extends from the master cylinder 4 to the wheel cylinders 7-3 to 7-4.

A solenoid valve 19 for performing pressure increase control for each wheel cylinder, and a solenoid valve 20 for performing pressure reduction control for each wheel cylinder are provided. The pressure increasing solenoid valves 19 are provided with check valves 21 (numeral is attached to only one) which allow return of fluid toward the pressure adjusting device 2 from the wheel cylinders. These solenoid valves are used for adjustment of braking force for the individual wheels, such as for pressure reduction and pressure re-increase during antilock control, which are carried out based on information from e.g. wheel speed sensors for the respective wheels. But these solenoid valves are not essential elements.

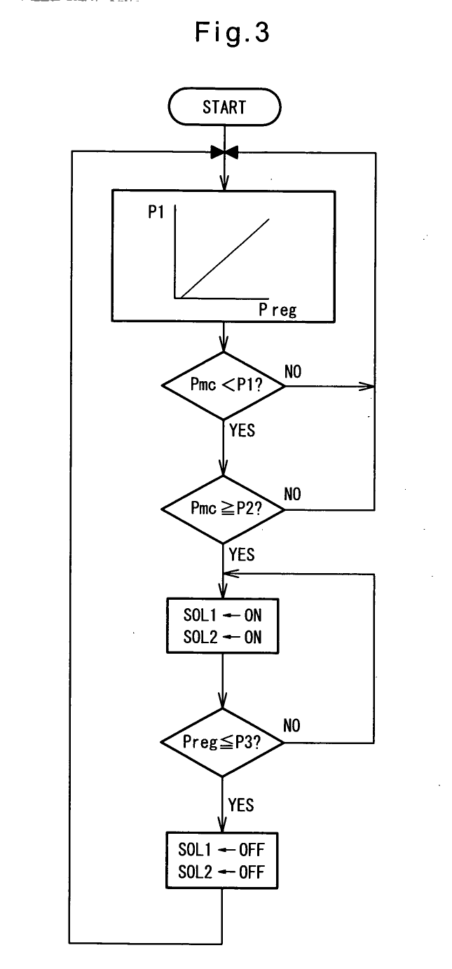

FIG. 3 shows an example of a flowchart for the supply of hydraulic pressure in the vehicle hydraulic brake device of FIG. 1. Data used as criterion for judgment of bottoming detection (relation between the output hydraulic pressure of the pressure adjusting valve 3 and that of the master cylinder 4) are input in the bottoming detecting means 15 beforehand, and the output hydraulic pressure Preg of the pressure adjusting valve 3 as detected by the pressure sensor 13 is compared with the output hydraulic pressure of the master cylinder 4 as detected by the master cylinder pressure sensor 14. If the output hydraulic pressure Pmc of the master cylinder 4 is smaller than a predetermined value P1 (condition Pmc<P1 is met), and is not less than a predetermined first hydraulic pressure P2 (Pmc≧P2), the solenoid valves 17 (SOL1) and 18 (SOL2) are turned on to supply the output hydraulic pressure of the pressure adjusting valve 3 to the second hydraulic system which extends from the master cylinder 4 to the wheel cylinders 7-3 and 7-4. Also, if an alarm device is provided, an alarm is given. At this time, the output hydraulic pressure of the pressure adjusting valve 3 flows to the second hydraulic system while deflecting the cup seal 4d which is on the outer periphery of the master piston 4a.

If the output hydraulic pressure Preg of the pressure adjusting valve 3 is not more than a predetermined second hydraulic pressure P3, the solenoid valves 17 and 18 are turned off to end the supply of hydraulic pressure. The second hydraulic pressure P3 is a hydraulic pressure when the brake pedal 1 has been returned and may be zero.

Here, the output hydraulic pressure of the pressure adjusting valve is compared with that of the master cylinder to detect bottoming of the master piston. But the bottoming may also be detected by detecting the stroke of the brake operating member such as the brake pedal 1 or the brake operating force applied to the brake pedal 1 and comparing it with the output hydraulic pressure of the master cylinder.

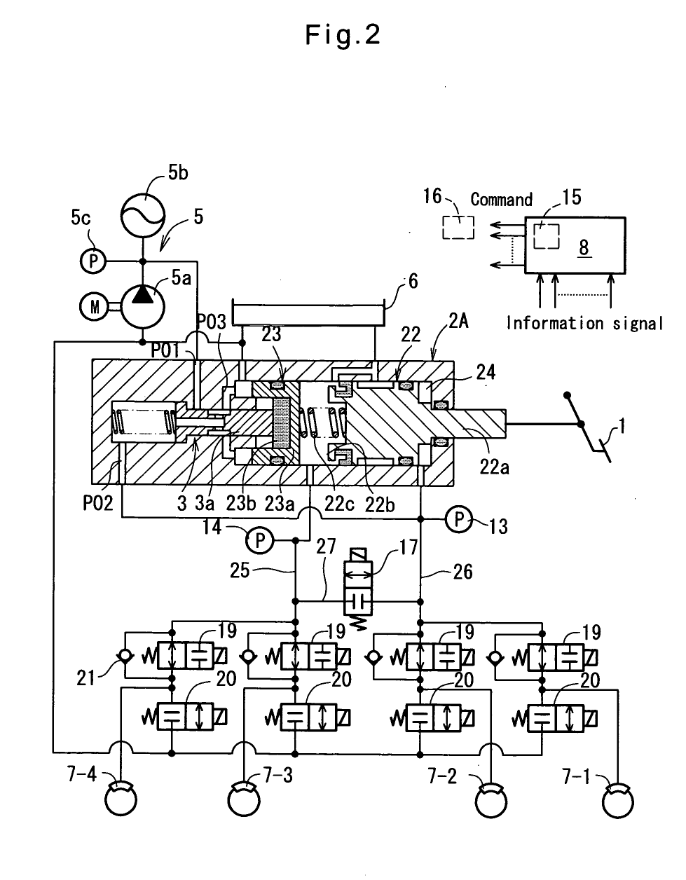

FIG. 2 is the second embodiment. The vehicle hydraulic brake device of FIG. 2 employs, instead of the pressure adjusting device 2 of FIG. 1, a pressure adjusting device 2A (which also has the boosting function). For elements common to the device of FIG. 1, the same numerals as in FIG. 1 are attached and its description is omitted. Below, only different points will be described.

A master cylinder 22 has a master piston 22a to which the brake operating force from the brake pedal 1 is applied. Brake fluid in a master hydraulic chamber 22b is pressurized by the master piston 22a to generate brake hydraulic pressure.

The brake operating force applied to the master piston 22a is transmitted to the pressure adjusting valve 3 through a return spring 22c of the master piston, brake hydraulic pressure in the master hydraulic chamber 22b and a distribution device 23.

The distribution device 23 includes a rubber member 23b arranged in a cup-like piston 23a to transmit the advancing thrust of the cup-like piston 23a to the pressure adjusting valve 3 through the rubber member 23b. While this distribution device 23 slightly differs in structure from the distribution device of FIG. 1, there is little functional difference.

The output hydraulic pressure of the pressure adjusting valve 3 is introduced through the output port P02 into a pressure chamber 24 provided in the rear of the master piston 22a, so that the master piston 22a advances under the brake operating force applied from the brake pedal 1 and the hydraulic pressure in the pressure chamber 24, which acts as an assisting force, producing brake hydraulic pressure proportional to the brake operating force in the master hydraulic chamber 22b.

The brake hydraulic pressure generated in the master cylinder 22 is supplied to the wheel cylinders 7-3 and 7-4, which are in the second hydraulic system. To the wheel cylinders 7-1 and 7-2, which are in the first hydraulic system, the output hydraulic pressure of the pressure adjusting valve 3 is supplied.

In the vehicle hydraulic brake device of FIG. 2, a communicating passage 27 is provided between a hydraulic passage 25 extending from the master cylinder 22 to the wheel cylinders 7-1 and 7-2 and a hydraulic passage 26 extending from the pressure adjusting valve 3 to the wheel cylinders 7-1 and 7-2 to connect them together, and a solenoid valve 17 is disposed in this communicating passage 27 so that the output hydraulic pressure of the pressure adjusting valve 3 can be supplied to the hydraulic passage 25 when necessary.

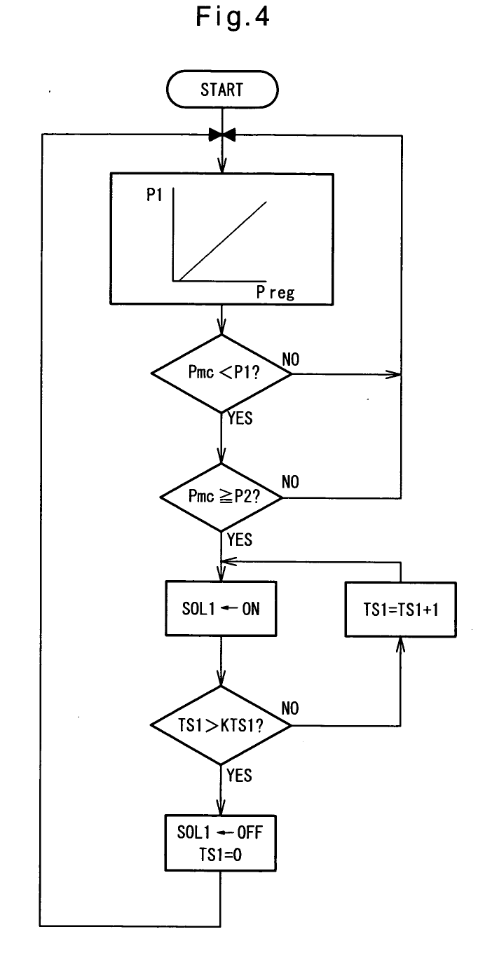

FIG. 4 shows an example of the flowchart for supply of hydraulic pressure in the vehicle hydraulic brake device of FIG. 2.

In the vehicle hydraulic brake device of FIG. 2, too, the output hydraulic pressure of the pressure adjusting valve detected by the pressure sensor 13 is compared with that of the master cylinder detected by the master cylinder pressure sensor 14, and if the conditions of Pmc<P1 and Pmc>P2 are met, the solenoid valve 17 (SOL1) is turned on to supply the output hydraulic pressure of the pressure adjusting valve 3 through the communicating passage 27 to the second hydraulic system, which extends from the master cylinder 22 to the wheel cylinders 7-3 and 7-4.

When the supply of hydraulic pressure is started by turning on the solenoid valve 17, the supply time TS1 is counted and continued until preset time KTS1 is passed. When the preset time has passed, the solenoid valve 17 is turned off to end the supply of hydraulic pressure, TS1 is reset and it returns to the start point.

As described above, with the vehicle hydraulic brake device of this invention, if bottoming of the master cylinder is detected by the bottoming detecting means, the output hydraulic pressure of the pressure adjusting valve is supplied to the hydraulic system extending from the master cylinder to wheel cylinders. Thus, even if vapor lock phenomenon develops, sufficient braking force is assured, so that the safety of the vehicle increases.

What is claimed is:

1. A vehicle hydraulic brake device comprising a hydraulic pressure source for generating and outputting a predetermined hydraulic pressure, a pressure adjusting valve for adjusting the output hydraulic pressure of said hydraulic pressure source to a value proportional to a brake operating amount, a pressure chamber, a master cylinder having a master piston actuated under the output hydraulic pressure of said pressure adjusting valve introduced into a pressure chamber, or under the output hydraulic pressure of said pressure adjusting valve introduced into a pressure chamber and the brake operating force to generate brake hydraulic pressure, and wheel cylinders actuated by the output hydraulic pressure from the master cylinder to impart braking force to the respective wheels,
further comprising a bottoming detector for detecting the bottoming of said master piston, and a hydraulic pressure supply device for supplying the output hydraulic pressure of said pressure adjusting valve to a hydraulic system extending from said master cylinder to said wheel cylinders, said hydraulic pressure supply device supplying the output hydraulic pressure of said pressure adjusting valve to said hydraulic system when said bottoming detector detects the bottoming of said master piston.

2. A vehicle hydraulic brake device as claimed in claim 1 wherein said hydraulic pressure supply device supplies the output hydraulic pressure of said pressure adjusting valve to said hydraulic system if said bottoming detector detects the bottoming of said master piston, and the output hydraulic pressure of said master cylinder at the time is not less than a predetermined first hydraulic pressure.

3. A vehicle hydraulic brake device as claimed in claim 1 wherein said hydraulic pressure supply device starts supplying hydraulic pressure to said hydraulic system when said bottoming detector detects the bottoming of said master piston, and stops supplying hydraulic pressure to said hydraulic system when the output hydraulic pressure of said master cylinder and/or the output hydraulic pressure of said pressure adjusting valve is not more than a predetermined second hydraulic pressure.

4. A vehicle hydraulic brake device as claimed in claim 2 wherein said hydraulic pressure supply device starts supplying hydraulic pressure to said hydraulic system when said bottoming detector detects the bottoming of said master piston, and stops supplying hydraulic pressure to said hydraulic system when the output hydraulic pressure of said master cylinder and/or the output hydraulic pressure of said pressure adjusting valve is not more than a predetermined second hydraulic pressure.

5. A vehicle hydraulic brake device as claimed in claim 1 wherein said hydraulic pressure supply device starts supplying hydraulic pressure to said hydraulic system when said bottoming detector detects the bottoming of said master piston, and stops supplying hydraulic pressure to said hydraulic system when a predetermined time has passed after starting supplying hydraulic pressure.

6. A vehicle hydraulic brake device as claimed in claim 2 wherein said hydraulic pressure supply device starts supplying hydraulic pressure to said hydraulic system when said bottoming detector detects the bottoming of said master piston, and stops supplying hydraulic pressure to said hydraulic system when a predetermined time has passed after starting supplying hydraulic pressure.

7. A vehicle hydraulic brake device as claimed in claim 1 wherein said hydraulic pressure supply device starts supplying hydraulic pressure to said hydraulic system when said bottoming detector detects the bottoming of said master piston, and stops supplying hydraulic pressure to said hydraulic system when a predetermined time has passed after said bottoming detector detects that as a result of supply of hydraulic pressure by said hydraulic pressure supply device, said master piston has recovered to a non-bottoming state.

8. A vehicle hydraulic brake device as claimed in claim 2 wherein said hydraulic pressure supply device starts supplying hydraulic pressure to said hydraulic system when said bottoming detector detects the bottoming of said master piston, and stops supplying hydraulic pressure to said hydraulic system when a predetermined time has passed after said bottoming detector detects that as a result of supply of hydraulic pressure by said hydraulic pressure supply device, said master piston has recovered to a non-bottoming state.

9. A vehicle hydraulic brake device as claimed in claim 1 wherein said bottoming detector includes an alarm for producing an alarm when it detects the bottoming of said master piston.

10. A vehicle hydraulic brake device as claimed in claim 2 wherein said bottoming detector includes an alarm for producing an alarm when it detects the bottoming of said master piston.
